(19) United States
(12) Patent Application Publication
(10) Pub. No.: US 2024/0054808 A1
(43) Pub. Date: Feb. 15, 2024

(54) INTELLIGENT MIRROR AND INTELLIGENT MIRROR AWAKENING METHOD

(71) Applicant: BOE Technology Group Co., Ltd., Beijing (CN)

(72) Inventor: Dianmeng LI, Beijing (CN)

(21) Appl. No.: 17/641,215

(22) PCT Filed: May 20, 2021
(86) PCT No.: PCT/CN2021/094980

§ 371 Date: Mar. 8, 2022

(30) Foreign Application Priority Data
Jun. 10, 2020 (CN) 202010524257.2

(51) Int. Cl. G06V 40/16; G02B 5/08; G06V 10/143; A47G 1/02; G06F 3/041; G06T 7/70

(52) U.S. Cl. CPC G06V 40/166; G02B 5/0808; G06V 10/143; A47G 1/02; G06F 3/0412; G06T 7/70

(57) ABSTRACT

An intelligent mirror and a method for awakening an intelligent mirror. The intelligent mirror includes: a mirror body, an image collecting module, a displaying module and a controller, wherein a surface of the mirror body is covered by a semi-transparent and semi-reflective film layer; a light-exiting face of the displaying module faces the mirror body, and the displaying module is configured for displaying an image in an operating state; the image collecting module is configured for collecting a human-face image of a user in the operating state; the controller is configured for, according to the human-face image, determining a face-orientation information of the user, when the face-orientation information satisfies a predetermined condition and a duration reaches a preset duration, awakening the displaying module to enter the operating state.

### CROSS REFERENCE TO RELEVANT APPLICATIONS

The present disclosure claims the priority of the Chinese patent application filed on Jun. 10, 2020 before the Chinese Patent Office with the application number of 202010524257.2 and the title of “INTELLIGENT MAGIC MIRROR AND INTELLIGENT MAGIC MIRROR AWAKENING METHOD”, which is incorporated herein in its entirety by reference.

### TECHNICAL FIELD

The present disclosure relates to the technical field of management of intelligent mirrors, and particularly relates to an intelligent mirror and a method for awakening an intelligent mirror.

### BACKGROUND

Intelligent mirrors are intelligent terminals that are, based on common mirrors, expanded into a terminal having the functions of displaying and interaction, and may realize functions such as weather broadcasting, information acquirement and music playing. According to the different application scenes, intelligent mirrors may be classified into bathroom mirrors, hallway mirrors, dressing-up mirrors and so on.

Currently, the mode for automatically awakening an intelligent mirror is conventionally to provide an infrared distance measuring module or a human-body proximity sensor on the intelligent mirror, which may realize automatic sleeping and screen lightening in certain distance and angle ranges. For example, a typical infrared distance measuring module may realize a detection range of 80 cm, when the user is in the 80 cm range from the intelligent mirror, the intelligent mirror may be automatically awakened, while when the user left that range, the intelligent mirror is controlled to be in a sleeping state.

### SUMMARY

The present disclosure provides an intelligent mirror and a method for awakening an intelligent mirror.

The present disclosure discloses an intelligent mirror, wherein the intelligent mirror comprises: a mirror body, an image collecting module, a displaying module and a controller;
a surface of the mirror body is covered by a semi-transparent and semi-reflective film layer;
a light-exiting face of the displaying module faces the mirror body, and the displaying module is configured for displaying an image in an operating state;
the image collecting module is configured for collecting a human-face image of a user
in the operating state; and
the controller is configured for, according to the human-face image, determining a face-orientation information of the user, and when the face-orientation information satisfies a predetermined condition and a duration reaches a preset duration, awakening the displaying module to enter the operating state.

Optionally, the intelligent mirror further comprises a distance measuring module;
the distance measuring module is configured for measuring a distance between the user and the mirror body; and
the controller is further configured for acquiring the distance, if the distance is in a preset distance range, generating an awakening signal, and sending the awakening signal to the image collecting module, to control the image collecting module to enter the operating state.

Optionally, the controller is further configured for acquiring a system time, if the system time is in a preset time period, awakening the distance measuring module, and if the system time is beyond the preset time period, shutting down the distance measuring module.

Optionally, the intelligent mirror further comprises an ambient-light detecting module;
the ambient-light detecting module is configured for detecting an ambient-light brightness of an environment where the mirror body is located; and
the controller is further configured for, if the ambient-light brightness is less than a brightness threshold, controlling the displaying module to be in a sleeping state.

Optionally, the displaying module comprises a display panel and a touch-controlling module; and

the display panel is configured for displaying an image, and the touch-controlling module is configured for performing a touch-controlling operation to a displaying face of the mirror body by the user.

Optionally, the image collecting module is an infrared shooting device.

Optionally, the intelligent mirror further comprises: a board card; and

the controller is disposed in the board card, and the board card is configured for supporting the image collecting module and the displaying module.

Optionally, the controller detects a human-face three-dimensional angle information by using an ArcFace-V2.0 algorithm, and by using the human-face three-dimensional angle information, determines the face-orientation information.

Optionally, the predetermined condition is that a front face of the user faces a displaying face of the mirror body.

The present disclosure discloses a method for awakening an intelligent mirror, applied to the intelligent mirror according to any one of the above items, wherein the method comprises:
when a distance between a user and the intelligent mirror is in a preset range, acquiring a human-face image of the user whose distance from the intelligent mirror is within the preset range;
according to the human-face image, determining a face-orientation information of the user; and
if the face-orientation information satisfies a predetermined condition and a duration reaches a preset duration, awakening the intelligent mirror.

Optionally, the step of, according to the human-face image, determining the face-orientation information of the user comprises:

according to the human-face image, calculating a yaw angle corresponding to a human face of the user; and
according to the yaw angle, determining the face-orientation information of the user. Optionally, the method further comprises:

acquiring an ambient-light brightness of an environment where the intelligent mirror is located; and
if the ambient-light brightness is less than a brightness threshold, controlling the intelligent mirror to be in a sleeping state.

The present disclosure further discloses an electronic device, wherein the electronic device comprises:

a memory storing a computer-readable code; and

one or more processors, wherein when the computer-readable code is executed by the one or more processors, the electronic device implements the method for awakening an intelligent mirror stated above.

The present disclosure further discloses a computer program, wherein the computer program comprises a computer-readable code, and when the computer-readable code is executed in an electronic device, the computer-readable code causes the electronic device to implement the method for awakening an intelligent mirror stated above.

The present disclosure further discloses a non-transitory computer-readable storage medium, wherein the non-transitory computer-readable storage medium stores a computer instruction, and the computer instruction, when executed by a processor, implements the method for awakening an intelligent mirror stated above.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly introduced below. Apparently, the figures that are described below are embodiments of the present disclosure, and a person skilled in the art can obtain other figures according to these figures without paying creative work.

FIG. 1 is a schematic structural diagram of the intelligent mirror according to an embodiment of the present disclosure;

FIG. 2 is a flow chart of the steps of the method for awakening an intelligent mirror according to an embodiment of the present disclosure;

FIG. 3 is a schematic diagram of the detection of three-dimensional angle according to an embodiment of the present disclosure;

FIG. 4 schematically shows a block diagram of an electronic device for implementing the method according to the present disclosure; and

FIG. 5 schematically shows a storage unit for maintaining or carrying a program code for implementing the method according to the present disclosure.

### DETAILED DESCRIPTION OF THE EMBODIMENTS

In order to make the above purposes, features and advantages of the present disclosure more apparent and understandable, the present disclosure will be described in further detail below with reference to the drawings and the particular embodiments. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

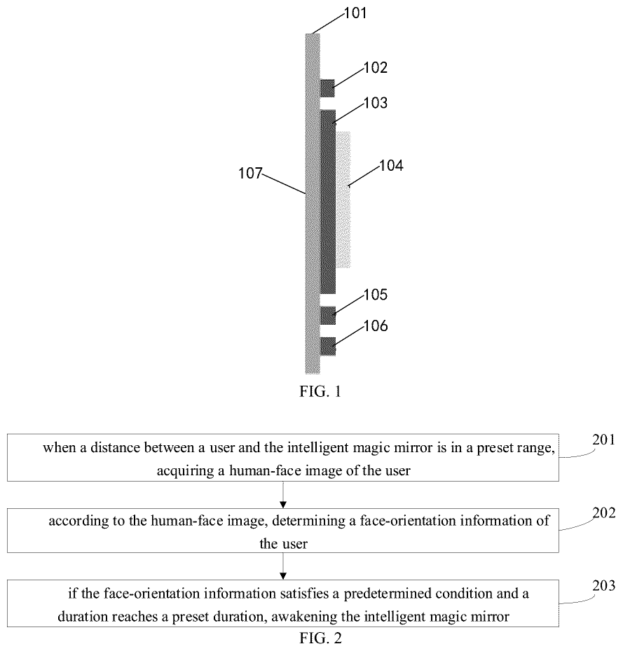

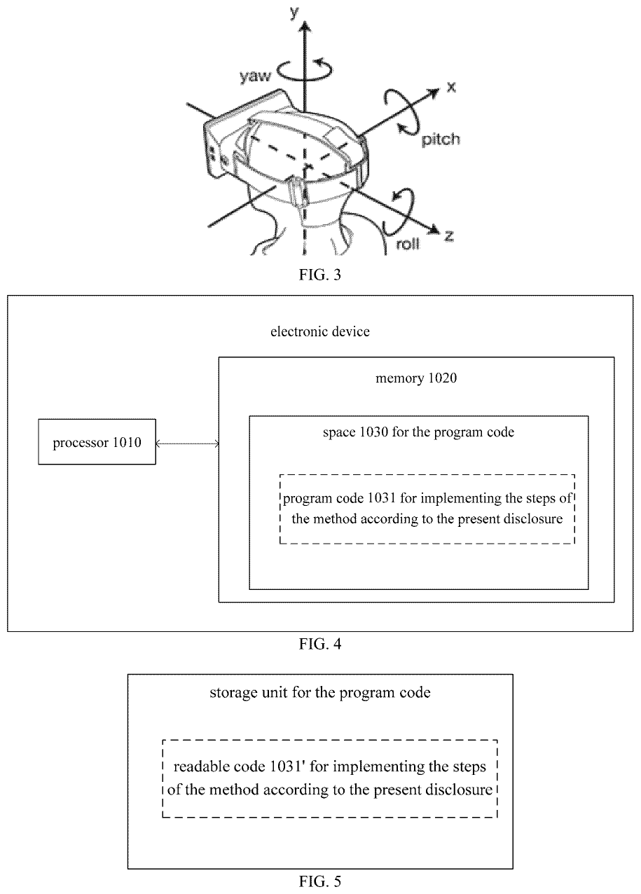

Referring to FIG. 1, FIG. 1 shows a schematic structural diagram of the intelligent mirror according to an embodiment of the present disclosure. As shown in FIG. 1, the intelligent mirror may comprise: a mirror body 101, an image collecting module 102, a displaying module 103 and a controller (not shown in the figure).

The surface of the mirror body 101 is covered by a semi-transparent and semi-reflective film layer. Particularly, the displaying face 107 of the mirror body 101 is plated by a half-reflecting film layer, which may use a typical transmission-to-reflection ratio: a reflectivity of 50% and a transmissivity of 30%, wherein the functional film layer may be configured as a film layer made from aluminum, and the outer layer is a protection layer of lithium dioxide and silicon dioxide.

The light-exiting face of the displaying module 103 faces the mirror body 101. Particularly, the light-exiting face of the displaying module 103 faces the face of the mirror body 101 that is opposite to the displaying face 107. The displaying module 103 may display an image in an operating state, for example, displaying information, animation and so on.

The image collecting module 102 may collect a human-face image of the user in the operating state. In the present embodiment, the image collecting module 102 may be an infrared shooting device, such as an infrared camera and so forth. The infrared camera has a high transmissivity, and may realize the shooting of the human face of the user in an environment of a low illuminance, which may increase the accuracy of the acquirement of the human face of the user, and prevent mis-awakening of the intelligent mirror.

The controller may, according to the human-face image collected by the image collecting module 102, determine the face-orientation information of the user, and when the face-orientation information satisfies a predetermined condition and the duration reaches a preset duration, awakening the displaying module to enter the operating state.

In the present embodiment, the predetermined condition refers to a condition for determining whether the face-orientation information of the user faces the displaying face 107 of the intelligent mirror.

The preset duration refers to a duration preset by the service personnel during which the face of the user faces the displaying face 107. In the present embodiment, the preset duration may be 10 s, 5 s and so on. Particularly, it may be set according to service demands, and is not limited in the present embodiment.

The intelligent mirror may further comprise a board card 104. The controller is disposed in the board card 104. The controller may acquire the human-face image of the user collected by the image collecting module 102, and determine the face-orientation information of the user by using the human-face image. Furthermore, when the face-orientation information of the user satisfies the predetermined condition and the duration reaches the preset duration, the controller controls the displaying module 103 to enter the operating state, at which point the displaying face 107 of the mirror body may display the corresponding image.

In a particular implementation, an algorithm of determining that the front face of the user faces the intelligent mirror may determine the face-orientation information of the user by detecting the three-dimensional angle of the human face. Particularly, the detection of the three-dimensional angle of the human face may be realized by using an ArcFace-V2.0 algorithm, which comprises the three space angles of the human face: a pitch angle (pitch), a roll angle (roll) and a yaw angle (yaw). The yaw angle (yaw) is used to determine the angle of the human face, to realize a detection precision better than 30°. In other words, when the yaw angle of the human face is within 30°, it is determined that the face-orientation information of the user satisfies the predetermined condition.

In the present embodiment, by referring to the face-orientation information of the user and the duration corresponding to the face-orientation information, it is determined whether the user has an intention to use the intelligent mirror, and, according to the result of the determination, it is determined whether to awaken the intelligent mirror, which may increase the accuracy of the awakening of the intelligent mirror, and prevent mis-awakening of the intelligent mirror, thereby improving the user experience, and saving the electric energy.

In the present embodiment, the intelligent mirror may further comprise a distance measuring module 105, as shown in FIG. 1. The distance measuring module 105 may measure the distance between the user and the mirror body 101. The controller may acquire the distance, if the distance is in a preset distance range, generate an awakening signal, and send the awakening signal to the image collecting module 102, to, by using the awakening signal, control the image collecting module 102 to enter the operating state.

In the present embodiment, only when the user is located in a range that the distance measuring module 105 is detectable, the image collecting module 102 may be triggered and awakened, while when the user is located beyond the range that the distance measuring module 105 is detectable, the image collecting module 102 is controlled to be in a sleeping state, which may further save the electric energy.

In a particular implementation of the present embodiment, it may be determined, by referring to the system time, whether to awaken the distance measuring module. Particularly, the controller may also acquire a system time, if the system time is in a preset time period, then awaken the distance measuring module, and if the system time is beyond the preset time period, then shut down the distance measuring module. For example, in a certain time period at night, the user is usually in the sleeping state, in which case, the distance measuring module may be shut down, to further save the electric energy.

In another particular implementation of the present embodiment, it may be determined, by referring to the ambient-light brightness, whether to awaken the displaying module.

As shown in FIG. 1, the intelligent mirror may further comprise an ambient-light detecting module 107. The ambient-light detecting module 107 may detect the ambient-light brightness of the environment where the mirror body 101 is located.

The controller may acquire the ambient-light brightness detected by the ambient-light detecting module 107, and if the ambient-light brightness is less than a brightness threshold, control the displaying module 103 to be in a sleeping state. For example, in a time period at night, the ambient-light brightness is low, at which point the user may sleep already, and the displaying module may be controlled to be in a sleeping state, to save the electric energy.

In the present embodiment, the displaying module 103 may further comprise a display panel and a touch-controlling module. The display panel may display the corresponding image. The touch-controlling module may be used for performing touch-controlling to the displaying face of the mirror body 101 by the user, to implement the touch controlling to the intelligent mirror.

In the intelligent mirror according to the present embodiment, when the face orientation of the user satisfies the predetermined condition and the duration reaches the preset duration, the displaying module is awakened to enter the operating state, to display the image by using the displaying module. The embodiments of the present disclosure, by referring to the face-orientation information of the user and the duration of the face-orientation information of the user, determine whether the user has an intention to use the intelligent mirror, thereby preventing mis-awakening of the intelligent mirror, improving the user experience, and saving the electric energy.

Referring to FIG. 2, FIG. 2 shows a flow chart of the steps of the method for awakening an intelligent mirror according to an embodiment of the present disclosure. The method for awakening an intelligent mirror may be applied to the intelligent mirror according to the above embodiments. As shown in FIG. 2, the method for awakening an intelligent mirror may particularly comprise the following steps:

Step 201: when a distance between a user and the intelligent mirror is in a preset range, acquiring a human-face image of the user whose distance from the intelligent mirror is in the preset range.

In the present embodiment, the intelligent mirror is provided with a distance measuring module. The distance measuring module may measure the distance between the user and the minor body of the intelligent mirror. When the distance between the user and the mirror body of the intelligent mirror is in a preset range, the image collecting module (such as an infrared camera) pre-disposed in the intelligent minor may be awakened.

After the image collecting module is started up, the human-face image of the user may be collected by using the image collecting module.

After the human-face image of the user is acquired, a step 202 is executed.

Step 202: according to the human-face image, determining a face-orientation information of the user.

The face-orientation information refers to the orientation of the human face of the user. In the present embodiment, the face-orientation information may be that the front face of the human face of the user faces the displaying face of the mirror body of the intelligent mirror, the side face of the user faces the displaying face of the mirror body, and so on.

After the human-face image of the user is acquired, the face-orientation information of the user may be determined according to the human-face image. Particularly, that may be described in detail with reference to the following particular implementations.

In a particular implementation of the present embodiment, the step 202 may comprise:

Sub-step S1: according to the human-face image, calculating a yaw angle corresponding to a human face of the user.

In the present embodiment, by detecting that the front face of the user faces the intelligent mirror or the side face of the user faces the intelligent mirror, it is determined whether the user has an intention to use the intelligent mirror, thereby reducing the frequency of mis-awakening. An algorithm of detecting that the front face of the user faces the intelligent minor may be an ArcFace-V2.0 algorithm. The ArcFace-V2.0 algorithm may implement the detection of the three-dimensional angle of the human face, wherein the detected human face may comprise the three space angles: a pitch angle (pitch), a roll angle (roll) and a yaw angle (yaw). In the present embodiment, the face-orientation information of the human face of the user may be determined by using the yaw angle.

After the yaw angle corresponding to the human face of the user is calculated according to the human-face image, a sub-step S2 is executed.

Sub-step S2: according to the yaw angle, determining the face-orientation information of the user.

After the yaw angle is calculated, the face-orientation information of the user may be determined by using the yaw angle. For example, if the yaw angle of the user relative to the minor body is less than or equal to 30°, that indicates that the front face of the user faces the minor body, while, if the yaw angle of the user relative to the mirror body is greater than 30°, that indicates that the side face of the user faces the mirror body.

After the face-orientation information of the user is acquired, a step 203 is executed.

Step 203: if the face-orientation information satisfies a predetermined condition and a duration reaches a preset duration, awakening the intelligent mirror.

The predetermined condition may refer to a pre-determined condition for determining whether the front face of the user faces the displaying face of the minor body.

The preset duration may refer to a pre-determined duration for determining whether the front face of the user faces the displaying face of the mirror body. In the present embodiment, the preset duration may be 5 s, 8 s and so on. Particularly, it may be set according to service demands, and is not limited in the present embodiment.

After the face-orientation information of the user is acquired, it is may be determined whether the face-orientation information satisfies the predetermined condition; in other words, it is determined according to the face-orientation information whether the front face of the user faces the displaying face of the mirror body.

If the face-orientation information satisfies the predetermined condition, then the duration of the face-orientation information of the user is determined; in other words, it is determined whether the duration during which the front face of the user faces the displaying face of the minor body reaches the preset duration. If the duration during which the front face of the user faces the displaying face of the mirror body reaches the preset duration, then the intelligent minor is awakened by using a pre-disposed controller. Particularly, the controller sends an awakening signal to the displaying module disposed in the intelligent minor, to awaken the displaying module, to display the corresponding image.

The present embodiment, by referring to the face-orientation information of the user and the duration of the face-orientation information of the user, determines whether the user has an intention to use the intelligent minor, thereby preventing mis-awakening of the intelligent minor.

Certainly, in the present embodiment, the operating state of the intelligent mirror may also be controlled according to the ambient-light brightness of the environment where the intelligent minor is located. Particularly, that may be described in detail with reference to the following particular implementations.

In a particular implementation of the present embodiment, the method may further comprise:
Step S1: acquiring an ambient-light brightness of an environment where the intelligent minor is located; and
Step S2: if the ambient-light brightness is less than a brightness threshold, controlling the intelligent mirror to be in a sleeping state.

In the present embodiment, the brightness threshold refers to a preset threshold for matching the ambient-light brightness. The particular numerical value of the brightness threshold may be set according to service demands, and is not limited in the present embodiment.

In a particular implementation, the intelligent mirror is pre-disposed with an ambient-light detecting module, to detect in real time the ambient-light brightness of the environment where the intelligent mirror is located, and if the ambient-light brightness is less than a brightness threshold, control the intelligent mirror to be in a sleeping state. For example, in a time period at night, the ambient-light brightness is low, at which point the user might have already slept, and the displaying module may be controlled to be in a sleeping state, to save the electric energy.

The method for awakening an intelligent mirror according to the embodiments of the present disclosure comprises, when a distance between a user and the intelligent mirror is in a preset range, acquiring a human-face image of the user; and according to the human-face image, determining a face-orientation information of the user, and if the face-orientation information satisfies a predetermined condition and a duration reaches a preset duration, awakening the intelligent mirror. The present embodiment, by referring to the face-orientation information of the user and the duration of the face-orientation information of the user, determines whether the user has an intention to use the intelligent mirror, thereby preventing mis-awakening of the intelligent mirror, improving the user experience, and saving the electric energy.

Regarding the above-described process embodiments, for brevity of the description, all of them are expressed as the combination of a series of actions, but a person skilled in the art should know that the present disclosure is not limited by the sequences of the actions that are described, because, according to the present disclosure, some of the steps may have other sequences or be performed at the same time. Secondly, a person skilled in the art should also know that all of the embodiments described in the description are preferable embodiments, and not all of the actions and the modules that they involve are required by the present disclosure.

In addition, an embodiment of the present disclosure further provides an electronic device, wherein the electronic device comprises a processor, a memory and a computer program that is stored in the memory and is executable in the processor, the processor, when executing the program, implements the method for awakening an intelligent mirror according to any one of the above items.

The above-described device embodiments are merely illustrative, wherein the units that are described as separate components may or may not be physically separate, and the components that are displayed as units may or may not be physical units; in other words, they may be located at the same one location, and may also be distributed to a plurality of network units. Some or all of the modules may be selected according to the actual demands to realize the purposes of the solutions of the embodiments. A person skilled in the art can understand and implement the technical solutions without paying creative work.

Each component embodiment of the present disclosure may be implemented by hardware, or by software modules that are operated on one or more processors, or by a combination thereof. A person skilled in the art should understand that some or all of the functions of some or all of the components of the electronic device according to the embodiments of the present disclosure may be implemented by using a microprocessor or a digital signal processor (DSP) in practice. The present disclosure may also be implemented as apparatus or device programs (for example, computer programs and computer program products) for implementing part of or the whole of the method described herein. Such programs for implementing the present disclosure may be stored in a computer-readable medium, or may be in the form of one or more signals. Such signals may be downloaded from an Internet website, or provided on a carrier signal, or provided in any other forms.

For example, FIG. 4 shows an electronic device that can implement the method according to the present disclosure. The electronic device traditionally comprises a processor 1010 and a computer program product or computer-readable medium in the form of a memory 1020. The memory 1020 may be electronic memories such as flash memory, EEPROM (Electrically Erasable Programmable Read Only Memory), EPROM, hard disk or ROM. The memory 1020 has the storage space 1030 of the program code 1031 for implementing any steps of the above method. For example, the storage space 1030 for program code may contain program codes 1031 for individually implementing each of the steps of the above method. Those program codes may be read from one or more computer program products or be written into the one or more computer program products. Those computer program products include program code carriers such as a hard disk, a compact disk (CD), a memory card or a floppy disk. Such computer program products are usually portable or fixed storage units as shown in FIG. 5. The storage unit may have storage segments or storage spaces with similar arrangement to the memory 1020 of the electronic device in FIG. 4. The program codes may, for example, be compressed in a suitable form. Generally, the storage unit contains a computer-readable code 1031′, which can be read by a processor like 1010. When those codes are executed by the electronic device, the codes cause the electronic device to implement each of the steps of the method described above.

The embodiments of the description are described in the mode of progression, each of the embodiments emphatically describes the differences from the other embodiments, and the same or similar parts of the embodiments may refer to each other.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

The intelligent mirror and the method for awakening an intelligent mirror according to the present disclosure have been described in detail above. The principle and the embodiments of the present disclosure are described herein with reference to the particular examples, and the description of the above embodiments is merely intended to facilitate to understand the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

1. An intelligent mirror, wherein the intelligent mirror comprises: a mirror body, an image collecting module, a displaying module and a controller;
a surface of the mirror body is covered by a semi-transparent and semi-reflective film layer;
a light-exiting face of the displaying module faces the mirror body, and the displaying module is configured for displaying an image in an operating state;
the image collecting module is configured for collecting a human-face image of a user in the operating state; and
the controller is configured for, according to the human-face image, determining a face-orientation information of the user, and when the face-orientation information satisfies a predetermined condition and a duration reaches a preset duration, awakening the displaying module to enter the operating state.

2. The intelligent mirror according to claim 1, wherein the intelligent mirror further comprises a distance measuring module;
the distance measuring module is configured for measuring a distance between the user and the mirror body; and
the controller is further configured for acquiring the distance, on the condition that the distance is in a preset distance range, the controller is further configured for generating an awakening signal, and sending the awakening signal to the image collecting module, to control the image collecting module to enter the operating state.

3. The intelligent mirror according to claim 2, wherein the controller is further configured for acquiring a system time, on the condition that the system time is in a preset time period, the controller is further configured for awakening the distance measuring module, and on the condition that the system time is beyond the preset time period, the controller is further configured for shutting down the distance measuring module.

4. The intelligent mirror according to claim 1, wherein the intelligent mirror further comprises an ambient-light detecting module;
the ambient-light detecting module is configured for detecting an ambient-light brightness of an environment where the mirror body is located; and
the controller is further configured for, on the condition that the ambient-light brightness is less than a brightness threshold, controlling the displaying module to be in a sleeping state.

5. The intelligent mirror according to claim 1, wherein the displaying module comprises a display panel and a touch-controlling module; and
the display panel is configured for displaying an image, and the touch-controlling module is configured for performing a touch-controlling operation to a displaying face of the mirror body by the user.

6. The intelligent mirror according to claim 1, wherein the image collecting module is an infrared shooting device.

7. The intelligent mirror according to claim 1, wherein the intelligent mirror further comprises: a board card; and
the controller is disposed in the board card, and the board card is configured for supporting the image collecting module and the displaying module.

8. The intelligent mirror according to claim 1, wherein the controller detects a human-face three-dimensional angle information by using an ArcFace-V2.0 algorithm, and by using the human-face three-dimensional angle information, determines the face-orientation information.

9. The intelligent mirror according to claim 1, wherein the predetermined condition is that a front face of the user faces a displaying face of the mirror body.

10. A method for awakening an intelligent mirror, applied to the intelligent mirror according to claim 1, wherein the method comprises:
acquiring a human-face image of a user whose distance from the intelligent mirror is in a preset range;
according to the human-face image, determining a face-orientation information of the user; and
on the condition that the face-orientation information satisfies a predetermined condition and a duration reaches a preset duration, awakening the intelligent mirror.

11. The method according to claim 10, wherein the step of, according to the human-face image, determining the face-orientation information of the user comprises:
according to the human-face image, calculating a yaw angle corresponding to a human face of the user; and
according to the yaw angle, determining the face-orientation information of the user.

12. The method according to claim 10, wherein the method further comprises:
acquiring an ambient-light brightness of an environment where the intelligent mirror is located; and
under the condition that the ambient-light brightness is less than a brightness threshold, controlling the intelligent mirror to be in a sleeping state.

13. An electronic device, wherein the electronic device comprises:
a memory storing a computer-readable code; and
one or more processors, wherein when the computer-readable code is executed by the one or more processors, the electronic device implements operations for awakening an intelligent mirror, wherein the operations comprise:
acquiring a human-face image of a user whose distance from the intelligent mirror is in a preset range;
according to the human-face image, determining a face-orientation information of the user; and
on the condition that the face-orientation information satisfies a predetermined condition and a duration reaches a preset duration, awakening the intelligent mirror.

14. (canceled)

15. A non-transitory computer-readable storage medium, wherein the non-transitory computer-readable storage medium stores a computer instruction, and the computer instruction, when executed by a processor, implements operations for awakening an intelligent mirror, wherein the operations comprise:
acquiring a human-face image of a user whose distance from the intelligent mirror is in a preset range;
according to the human-face image, determining a face-orientation information of the user; and
on the condition that the face-orientation information satisfies a predetermined condition and a duration reaches a preset duration, awakening the intelligent mirror.

16. The electronic device according to claim 13, wherein the operation of, according to the human-face image, determining the face-orientation information of the user comprises:
according to the human-face image, calculating a yaw angle corresponding to a human face of the user; and
according to the yaw angle, determining the face-orientation information of the user.

17. The electronic device according to claim 13, wherein the operations further comprise:
acquiring an ambient-light brightness of an environment where the intelligent mirror is located; and
under the condition that the ambient-light brightness is less than a brightness threshold, controlling the intelligent mirror to be in a sleeping state.

18. The non-transitory computer-readable storage medium according to claim 15, wherein the operation of, according to the human-face image, determining the face-orientation information of the user comprises:
according to the human-face image, calculating a yaw angle corresponding to a human face of the user; and
according to the yaw angle, determining the face-orientation information of the user.

19. The non-transitory computer-readable storage medium according to claim 15, wherein the operations further comprise:
acquiring an ambient-light brightness of an environment where the intelligent mirror is located; and
under the condition that the ambient-light brightness is less than a brightness threshold, controlling the intelligent mirror to be in a sleeping state.
